(19) United States
(12) Patent Application Publication
(10) Pub. No.: US 2025/0231761 A1
(43) Pub. Date: Jul. 17, 2025

(54) DATA PROCESSING SYSTEM CAPABLE OF MANAGING APPLICATION SYSTEM FILES

(71) Applicant: TrustONE Security Inc., Taipei City (TW)

(72) Inventors: Po-Shao WU, Taipei City (TW); Yuan-Hao CHEN, Taipei City (TW); Chen-Hung LIAO, Taipei City (TW)

(21) Appl. No.: 19/024,253

(22) Filed: Jan. 16, 2025

(30) Foreign Application Priority Data
Jan. 16, 2024 (TW) 113101730

(51) Int. Cl. G06F 8/65; G06F 8/71; G06F 9/445; G06F 9/448; G06F 9/50

(52) U.S. Cl. CPC G06F 8/65; G06F 8/71; G06F 9/44536; G06F 9/4484; G06F 9/5038

(57) ABSTRACT

A data processing system, capable of managing a plurality of current operating system files associated with an application system, includes at least one processor. The at least one processor executes an operating system. The application system is resident in an application layer of the operating system, and functions in executing the current application system files. The operating system includes a scheduler, a file compare module, a backup storage module, and a file notifier. The file compare module can operate in a protected mode or an updated mode. When operating in the protected mode, the file compare module does not allow the current application system files associated with the application system to be modified.

### CROSS-REFERENCE TO RELATED APPLICATION

This utility application claims priority to Taiwan Application Serial Number 113101730, filed Jan. 16, 2024, which is incorporated herein by reference.

### BACKGROUND OF THE INVENTION

### 1. Field of the invention

The invention relates to a data processing system capable of managing application system files, and more in particular, to a data processing system whose operating system is capable of operating in different modes to manage application system files.

### 2. Description of the prior art

The current data processing system can run windows, Linux, Unix, Mac OS and other operating systems, will then install webpage system, enterprise resource planning (ERP) system, customer relationship management (CRM) system, Office application published by Microsoft corp. and other application systems.

After the installation of an application system, it is necessary to keep track of the updated application system files, information, and so on, in order to update the version of the application system in the future. Currently, most of the modifications in the application system files of these application systems are not set to be automatically updated as in the case of operating systems such as Windows, and have to be updated manually. These application system files include program components whose filename extensions are for example .dll, .exe, etc., and web page files whose filename extensions are for example .html, .jsp, etc. If there is any problem with these application files, the application system cannot track and manage them effectively.

In the past, the work of recording updated application system files and information was mostly managed manually by manually recording the updated version information. Referring to FIG. 1, FIG. 1 is a schematic diagram of a plurality of version information 1 associated with an application system stored in a data processing system of the prior art. The plurality of version information 1 are created by an administrator of the data processing system during multiple updates of the application system. As shown in FIG. 1, generally, the updated version information 1 includes the updated date, the modified application files, the note information, etc. The note information can include added functions, corrected problems, etc.

However, manual recording of updated version information has the following disadvantages. Firstly, manual recording of updated version information will inevitably omit updated application system files without any record. Furthermore, the administrator of the data processing system may have no management over the modifications made to the application system files without any record. Furthermore, application system files may have been deliberately modified by malicious people, so it is unlikely that updated version information would be recorded.

In addition, when the administrator of the data processing system wants to record the updated version information related to the modified application system files, apart from manually recording the updated version information, he/she can also install the version sensing module, for example, the “commit” instruction, “check in” instruction, or other recorded version update instructions, which will automatically record the modifications of the application system files, and then the administrator will enter the text information to be noted, and then the updated version information can be completed.

Although it is possible to execute a recorded version update instruction to assist the administrator of the data processing system to automatically record the modified application system files. However, if the administrator of the data processing system has modified the application system files arbitrarily, there will not be any record if the recorded version update instruction is not executed. Moreover, application system files may be deliberately modified by malicious parties, and if the administrator of the data processing system does not execute the recorded version update instruction immediately, it is unlikely that there will be any record of the updated version information.

### SUMMARY OF THE INVENTION

Accordingly, one scope of the invention is to provide a data processing system whose operating system is capable of operating in different modes to manage application system files to resolve past problems related to modifications in application system files.

A data processing system according to a preferred embodiment of the invention is capable of managing a plurality of current operating system files associated with an application system. The data processing system according to the preferred embodiment of the invention includes at least one processor. The at least one processor functions in executing an operating system. The operating system has a system layer and an application layer, and includes a scheduler, a file compare module, a backup storage module, and a file notifier. The application system is resident in the application layer, and functions in executing the plurality of current application system files associated with the application system. The scheduler is resident in the application layer, and therein stores a plurality of allowable update time slots. The file compare module is resident in the application layer, and is respectively coupled to the application system and the scheduler. The backup storage module is resident in the application layer, and is coupled to the file compare module. The backup storage module therein stores the plurality of application system files associated with the application system. The file notifier is resident in the system layer. The file notifier monitors whether at least one of the plurality of current application system files associated with the application system has been modified into at least one modified application system file, and if any, the file notifier sends a notification message to the file compare module. The file compare module determines whether a current time falls within one of the plurality of allowable update time slots, and if no, the file compare module operates in a protected mode. When operating in the protected mode, the file compare module, responsive to the notification message, determines whether there is a difference between at least one corresponding application system file of the current application system files associated with the application system stored in the backup storage module corresponding to the at least one modified application system file and the at least one modified application system file, and if any, the file compare module replaces the at least one modified application system file with the at least one corresponding application system file.

Further, the file compare module determines whether the current time falls within one of the plurality of allowable update time slots, and if yes, the file compare module operates in an updated mode. When operating in the updated mode, the file compare module, responsive to the notification message, records the at least one modified application system file.

Further, the data processing system according to the preferred embodiment of the invention also includes a version control module. The version control module is resident in the application layer, and is coupled to the file compare module. When said one allowable update time slot ends, the file compare module replaces the at least one corresponding application system file of the current application system files associated with the application system stored in the backup storage module with the at least one modified application system file. The file compare module sends the at least one modified application system file to the version control module, the version control module executes a recorded version update instruction to obtain an updated version information associated with the least one modified application system file.

In one embodiment, a filename extension of one of the plurality of current application system files can be .exe, .dll, .html, .jsp and so on.

In one embodiment, the recorded version update instruction can be a commit instruction, a check in instruction, or other recorded version update instruction.

In one embodiment, the data processing system according to the preferred embodiment of the invention is capable of communicating with a remote server. The remote server therein stores at least one previous version information. The version control module sends the updated version information to the remote server. The remote server stores the updated version information.

Distinguishable from the prior art, the operating system of the data processing system according to the invention can operate in different modes. Thereby, the operating system of the data processing system according to the invention can operate in a protected mode to prevent malicious people from intentionally modifying application system files. The operating system of the data processing system according to the present invention can operate in an updated mode to automatically generate an updated version information associated with the least one modified application system file.

The advantage and spirit of the invention may be understood by the following recitations together with the appended drawings.

### BRIEF DESCRIPTION OF THE APPENDED DRAWINGS

FIG. 1 is a schematic diagram of a plurality of version information associated with an application system stored in a data processing system of the prior art.

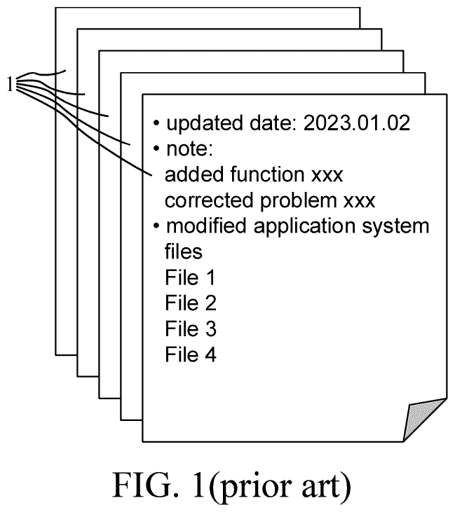

FIG. 2 is a schematic diagram of an architecture regarding management of application system files of a data processing system according to the preferred embodiment of the invention.

### DETAILED DESCRIPTION OF THE INVENTION

Some preferred embodiments and practical applications of this present invention would be explained in the following paragraph, describing the characteristics, spirit, and advantages of the invention.

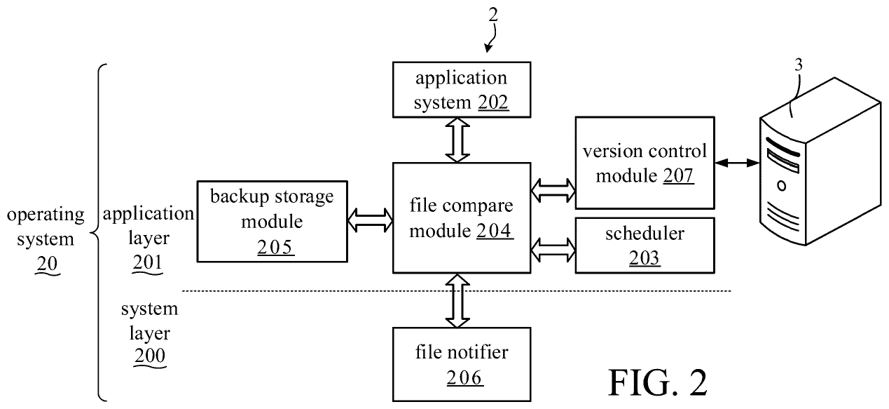

Referring to FIG. 2, the architecture regarding management of application system files of the data processing system 2 according to the preferred embodiment of the invention is shown in FIG. 2.

In one embodiment, the data processing system 2 according to the preferred embodiment of the invention can be one of various data processing systems such as a notebook computer, a desktop computer, a tablet computer, a smart phone, an industrial computer, a server, and the like.

As shown in FIG. 2, the data processing system 2 according to the preferred embodiment of the invention includes at least one processor (not shown in FIG. 2).

The at least one processor functions in executing an operating system 20 such as windows, Linux, Unix, Mac OS and other operating systems. The operating system 20 has a system layer 200 and an application layer 201. The data processing system 2 according to the preferred embodiment of the invention is capable of managing a plurality of current operating system files associated with an application system 202. The application system 202 is resident in the application layer 201 of the operating system 20, and functions in executing the plurality of current application system files associated with the application system 202. The application system 202 can be a webpage system, an ERP system, a CRM system, the Office application published by Microsoft corp. and other application systems.

The operating system 20 includes a scheduler 203, a file compare module 204, a backup storage module 205, and a file notifier 206. The scheduler 203 is resident in the application layer 201 of the operating system 20, and therein stores a plurality of allowable update time slots. The operating system 20 can provide a graphical user interface (GUI) (not shown in FIG. 2) for the administrator of the data processing system 2 according to the preferred embodiment of the invention to edit the plurality of allowable update time slot.

The file compare module 204 is resident in the application layer 201 of the operating system 20, and is respectively coupled to the application system 202 and the scheduler 203. The backup storage module 205 is resident in the application layer 201 of the operating system 20, and is coupled to the file compare module 204. The backup storage module 205 therein stores the plurality of application system files associated with the application system 202.

The file notifier 206 is resident in the system layer 200 of the operating system 20.

Modifications of the plurality of current application system files refer to modification of storage in at least one physical storage device (not shown in FIG. 2), therefore, the file notifier 206, resident in the system layer 200 of the operating system 20, can monitor whether at least one of the plurality of current application system files associated with the application system 202 has been modified into at least one modified application system file. And if any, the file notifier 206 sends a notification message to the file compare module 204. Modifications of the current application system files means that the current application system files have been modified, deleted or added, etc.

The file compare module 204 determines whether a current time falls within one of the plurality of allowable update time slots, and if no, the file compare module 204 operates in a protected mode.

When operating in the protected mode, the file compare module 204, responsive to the notification message, determines whether there is a difference between at least one corresponding application system file of the current application system files associated with the application system 202 stored in the backup storage module 205 corresponding to the at least one modified application system file and the at least one modified application system file, and if any, the file compare module 204 replaces the at least one modified application system file with the at least one corresponding application system file. Thereby, the operating system 20 of the data processing system 2 according to the invention can operate in the protected mode to prevent malicious people from intentionally modifying the application system files.

In one embodiment, a filename extension of one of the plurality of current application system files can be the filename extension of a program component such as .dll, .exe and so on, or the filename extension of a web page file such as .html, .jsp and so on.

Further, the file compare module 204 determines whether the current time falls within one of the plurality of allowable update time slots, and if yes, the file compare module 204 operates in an updated mode. When operating in the updated mode, the file compare module 204, responsive to the notification message, records the at least one modified application system file.

Further, the data processing system 2 according to the preferred embodiment of the invention also includes a version control module 207. The version control module 207 is resident in the application layer 201 of the operating system 20, and is coupled to the file compare module 204. When said one allowable update time slot ends, the file compare module 204 replaces the at least one corresponding application system file of the current application system files associated with the application system 202 stored in the backup storage module 205 with the at least one modified application system file. The file compare module 204 sends the at least one modified application system file to the version control module 207, the version control module 207 executes a recorded version update instruction to obtain an updated version information associated with the least one modified application system file.

In one embodiment, the recorded version update instruction can be a commit instruction, a check in instruction, or other recorded version update instruction.

In one embodiment, the data processing system 2 according to the preferred embodiment of the invention is capable of communicating with a remote server 3. The remote server 3 therein stores at least one previous version information. The version control module 207 sends the updated version information to the remote server 3. The remote server 3 stores the updated version information. Thereby, the remote server 3 can back up version information about each version of the plurality of application system files associated with the operating system 20.

With the detailed description of the above preferred embodiments of the invention, it is clear to understand that the operating system of the data processing system according to the invention can operate in the protected mode or the updated mode. Thereby, the operating system of the data processing system according to the invention can operate in the protected mode to prevent malicious people from intentionally modifying application system files. The operating system of the data processing system according to the present invention can operate in the updated mode to automatically generate an updated version information associated with the least one modified application system file.

With the example and explanations above, the characteristics and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system, capable of managing a plurality of current operating system files associated with an application system, comprising:
at least one processor, functioning in executing an operating system, the operating system having a system layer and an application layer, wherein the application system is resident in the application layer, and functions in executing the plurality of current application system files associated with the application system, the operating system comprising:
a scheduler, resident in the application layer and therein storing a plurality of allowable update time slots;
a file compare module, resident in the application layer and respectively coupled to the application system and the scheduler;
a backup storage module, resident in the application layer and coupled to the file compare module, the backup storage module therein storing the plurality of application system files associated with the application system; and
a file notifier, resident in the system layer, wherein the file notifier monitors whether at least one of the plurality of current application system files associated with the application system has been modified into at least one modified application system file, and if any, the file notifier sends a notification message to the file compare module,
wherein the file compare module determines whether a current time falls within one of the plurality of allowable update time slots, and if no, the file compare module operates in a protected mode, when operating in the protected mode, the file compare module, responsive to the notification message, determines whether there is a difference between at least one corresponding application system file of the current application system files associated with the application system stored in the backup storage module corresponding to the at least one modified application system file and the at least one modified application system file, and if any, the file compare module replaces the at least one modified application system file with the at least one corresponding application system file.

2. The data processing system of claim 1, wherein the file compare module determines whether the current time falls within one of the plurality of allowable update time slots, and if yes, the file compare module operates in an updated mode, when operating in the updated mode, the file compare module, responsive to the notification message, records the at least one modified application system file.

3. The data processing system of claim 2, wherein the operating system further comprises:
a version control module, resident in the application layer and coupled to the file compare module,
wherein when said one allowable update time slot ends, the file compare module replaces the at least one corresponding application system file of the current application system files associated with the application system stored in the backup storage module with the at least one modified application system file,
the file compare module sends the at least one modified application system file to the version control module, the version control module executes a recorded version update instruction to obtain an updated version information associated with the least one modified application system file.

4. The data processing system of claim 3, capable of communicating with a remote server, wherein the remote server therein stores at least one previous version information, the version control module sends the updated version information to the remote server, and the remote server stores the updated version information.

5. The data processing system of claim 4, wherein a filename extension of one of the plurality of current application system files is one selected from the group consisting of .exe, .dll, .html, and .jsp.

6. The data processing system of claim 4, wherein the recorded version update instruction is a commit instruction or a check in instruction.
